(19) United States
(12) Patent Application Publication
(10) Pub. No.: US 2010/0170064 A1
(43) Pub. Date: Jul. 8, 2010

(54) HINGE ASSEMBLY

(75) Inventors: LIAN-CHENG HUANG, Shenzhen City (CN); SHEN LI, Shenzhen City (CN); JIN-XIN WANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) Co., LTD., Shenzhen City (CN); HON HAI PRECISION INDUSTRY CO., LTD., Tu-Cheng (TW)

(21) Appl. No.: 12/536,612

(22) Filed: Aug. 6, 2009

(30) Foreign Application Priority Data
Jan. 7, 2009 (CN) 200910300096.2

(51) Int. Cl. E05D 5/02

(52) U.S. Cl. 16/387

(57) ABSTRACT

A hinge assembly includes a first rotation member and a second rotation member. The first rotation member includes an elastic coiled support portion. The second rotation member includes an elastic rotation portion. The rotation portion defines a cavity. The support portion is rotatably received in the cavity of the rotation portion.

### BACKGROUND

1. Technical Field

The disclosure relates to a hinge assembly employed in an electronic device.

2. Description of the Related Art

A typical electronic device includes a main body, a cover, and a hinge assembly hinging the cover on the main body. The hinge assembly includes a pivot shaft, a support frame, a rotating member, a plurality of elastic members, and a fixing member. The support frame, the rotating member, and the elastic members are sleeved on the pivot shaft. The support frame is fixed on the main body and is rotatable relative to the pivot shaft. The rotating member is fixed on the cover and is non-rotatable relative to the pivot shaft. The elastic members drive the rotating member such that the rotating member abuts the support frame. Therefore, the rotating member can remain in any desired position due to friction between the rotating member and the support frame.

However, this structure of the electronic device is complicated, and costly to manufacture.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a first embodiment of a hinge assembly.

FIG. 2 is an exploded, isometric view of the hinge assembly in FIG. 1.

FIG. 3 is a cross-section of the hinge assembly of FIG. 1, taken along line III-III.

FIG. 4 is a cross-section of a second embodiment of a hinge assembly.

FIG. 5 is a cross-section of a third embodiment of a hinge assembly.

### DETAILED DESCRIPTION

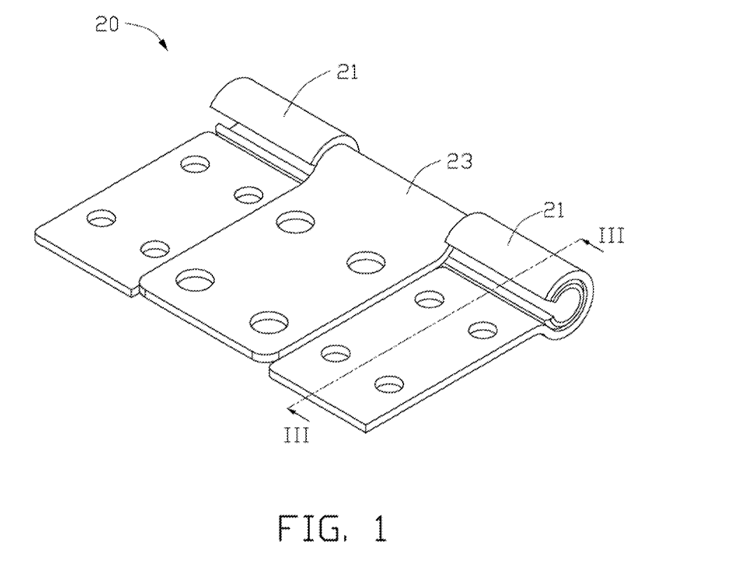

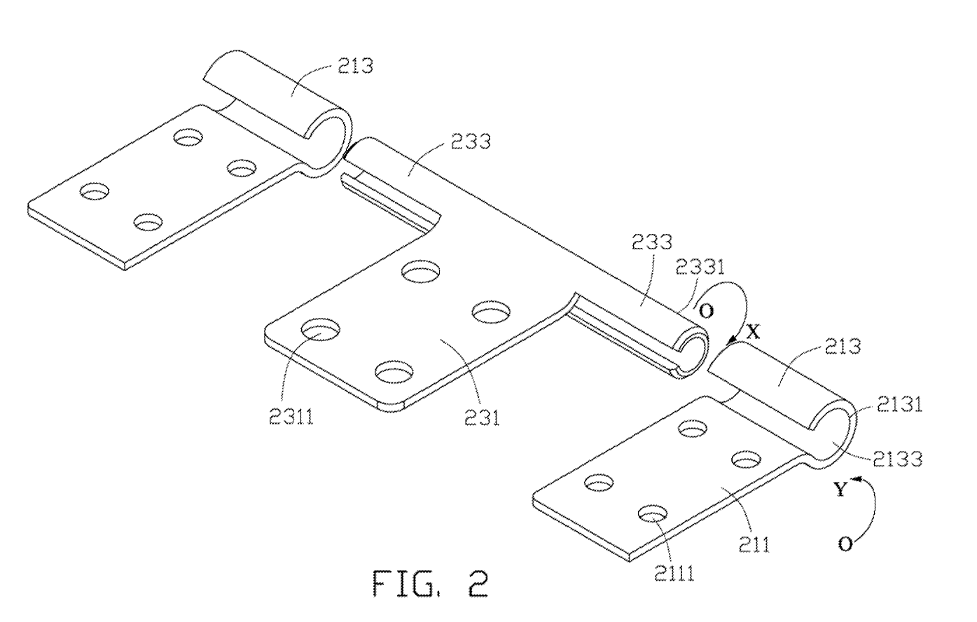

Referring to FIGS. 1 and 2, a first embodiment of a hinge assembly 20 includes a first rotation member 23 and two second rotation members 21.

The first rotation member 23 is elastic and may be made of metal, such is stainless steel which has good resistance to abrasion and a long fatigue life. The first rotation member 23 includes a base plate 231 and two coiled support portions 233 formed on opposite sides of an end of the base plate 231. The base plate 231 defines a plurality of assembly holes 2311. Each support portion 233 is coiled, for example, along a first direction OX to define a substantially cylindrical cavity (not labeled) and has a curved outer surface 2331. An end of the support portion 233 away from the base plate 231 does not contact the base plate 231, thus the support portion 233 and the base plate 231 cooperatively define a slot (not labeled). In the illustrated embodiment, the first rotation member 23 can be manufactured from one single piece of sheet metal. Alternatively the coiled support portions 233 can be attached to the base plate 231 by means such as welding.

The second rotation members 21 may be of the same material as the first rotation member 23. Each second rotation member 21 includes a connecting portion 211 and a coiled rotation portion 213. The connecting portion 211 defines a plurality of assembly holes 2111. The rotation portion 213 is coiled from an end of the connecting portion 211, for example, along a second direction OY opposite to the first direction OX, and has a curved inner surface 2131. In other words, the inner surface 2131 of the rotation portion 213 defines a substantially cylindrical cavity 2133. An inner diameter of the cylindrical cavity 213 of the rotation portion 213 of the second rotation member 21 is slightly less than an outer diameter of the support portion 233 of first rotation member 23 before assembly.

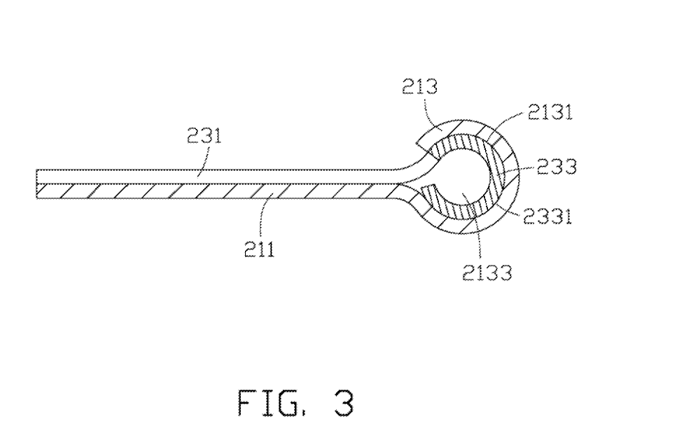

Referring to FIG. 3, during assembly, the two support portions 233 of the first rotation member 23 are rotatably received in the two cavities 2133 of the rotation portions 213 of the second rotation members 21.

The first rotation member 23 may be fixed on a cover (not shown) of a notebook computer, and the second rotation member 21 may be fixed on a main body (not shown) of the notebook computer. In one embodiment, a plurality of locking members such as screws (not shown) pass through the assembly holes 2311 of the first rotation member 23 such that the first rotation member 23 is fixed on the cover of the notebook computer, and a plurality of locking members such as screws pass through the assembly holes 2111 of the second rotation members 21 such that the second rotation member 21 is fixed on the main body of the notebook computer.

After the support portions 233 of the first rotation member 23 are received in the two cavities 2133 of the second rotation members 21, the support portions 233 are compressed, thereby storing an elastic force urging against the inner surfaces 2131 of the second rotation members 21. Accordingly, the rotation portions 213 are expanded thereby storing an elastic force urging against the outer surfaces 2331 of the support portions 233. Thus, the outer surfaces 2331 of the support portions 233 resist the inner surfaces 2131 of the rotation portions 213 of the second rotation members 23.

An external force applied to the cover rotates the first rotation member 23. The cover can remain in any desired position due to friction between the outer surfaces 2331 of the support portions 233 of the first rotation member 23 and the inner surfaces 2131 of the rotation portions 213 of the second rotation members 21.

Furthermore, a contact area between the support portions 233 of the first rotation member 23 and the rotation portions 213 of the second rotation members 21 is constant. As a result, friction between the support portions 233 of the first rotation member 23 and the rotation portions 213 of the second rotation members 21 is constant. Therefore, the cover hinges smoothly.

Alternatively, one of the support portions 233 of the first rotation member 23 and one of the second rotation members 21 may be omitted.

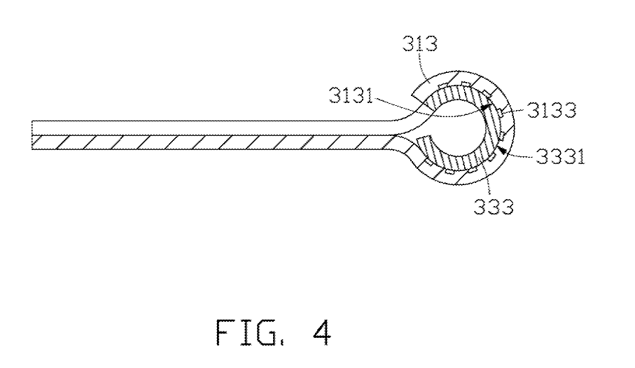

Referring to FIG. 4, a second embodiment of a hinge assembly (not labeled) differs from the first embodiment of the hinge assembly 20 because a plurality of depressions 3133 are defined in inner surfaces 3131 of rotation portions 313 of second rotation members 31 to store lubricant oil therein.

A shape of the depressions 3133 can be any shape such as hemispherical, wedge-shaped, rectangular, and so on. Alternatively, the depressions 3133 may be defined in outer surfaces 3331 of support portions 333 of a first rotation member 33.

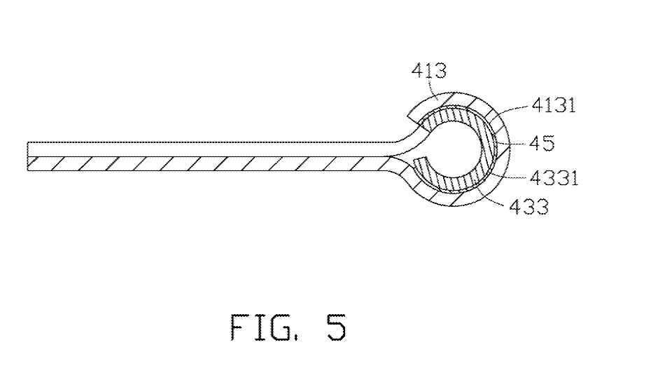

Referring to FIG. 5, a third embodiment of a hinge assembly (not labeled) differs from the first embodiment of the hinge assembly 20 because an elastic abrasion resistant sheet 45 is positioned between inner surfaces 4131 of rotation portions 413 of a second rotation members 41 and an outer surface 4331 of support portions 433 of a first rotation member 43 to reduce abrasion of the first rotation member 43 and the second rotation members 41.

Finally, while various embodiments have been described and illustrated, the embodiments are not to be construed as being limited thereto. Various modifications can be made to the embodiments by those skilled in the art without departing from the true spirit and scope of the embodiments as defined by the appended claims.

What is claimed is:

1. A hinge assembly, comprising:
a first rotation member comprising at least one elastic coiled support portion; and
at least one second rotation member manufactured from one single piece of sheet metal, and comprising an elastic rotation portion, the rotation portion defining a cavity in which the at least one support portion is rotatably received.

2. The hinge assembly of claim 1, wherein the at least one support portion is made of metal, exerts a force on the rotation portion after the at least one support portion is received in the cavity of the rotation portion due to elastic deformation.

3. The hinge assembly of claim 1, wherein the rotation portion comprises a curved inner surface, and the at least one support portion comprises a curved outer surface engaging with the curved inner surface.

4. The hinge assembly of claim 1, wherein the at least one second rotation member comprises two second rotation members; the first rotation member further comprising a base plate; least one elastic coiled support portion comprises two coiled support portions coiled from the base plate along a first direction to define two substantially cylindrical cavities; each second rotation member further comprising a connecting portion connected to an end of the rotation portions; the rotation portions are coiled along a second direction opposite to the first direction.

5. The hinge assembly of claim 4, wherein an end of the support portions of the first rotation member away from the base plate does not contact the base plate such that the support portions and the base plate cooperatively define a slot.

6. The hinge assembly of claim 1, wherein the rotation portion is made of stainless steel.

7. The hinge assembly of claim 1, wherein an inner surface of the rotation portion defines a plurality of depressions.

8. The hinge assembly of claim 1, wherein an outer surface of the at least one coiled support portion defines a plurality of depressions.

9. The hinge assembly of claim 1, further comprising an abrasion resistant sheet positioned between an inner surface of the rotation portion of the at least one second rotation member and an outer surface of the at least one support portion of the first rotation member.
